(19) United States
(12) Patent Application Publication
(10) Pub. No.: US 2025/0228734 A1
(43) Pub. Date: Jul. 17, 2025

(54) Tapping Apparatus and Massager

(71) Applicant: Shenzhen Envision Technology Innovation Co., Ltd., Shenzhen (CN)

(72) Inventor: Hui Zeng, Shenzhen (CN)

(21) Appl. No.: 18/624,089

(22) Filed: Apr. 1, 2024

(30) Foreign Application Priority Data
Jan. 17, 2024 (CN) 202420117170.7

(51) Int. Cl. A61H 19/00; A61H 23/00; A61H 23/02

(52) U.S. Cl. CPC A61H 19/44; A61H 19/34; A61H 23/006; A61H 23/02; A61H 2201/123

(57) ABSTRACT

A tapping apparatus includes a linear direct-current motor, a connecting member including a first end and a second end, and an elongated swing member. The motor includes a mover that moves along a longitudinal axis, the mover being connected with the first end of the connecting member, and the second end of the connecting member is connected to the elongated swing member. When the mover moves linearly back and forth, the elongated swing member rotates about a pivoting axis emanating from the connecting member. A massager including the tapping apparatus is also provided.

### TECHNICAL FIELD

The present invention relates to the field of healthcare massage products, specifically to a tapping apparatus and massager.

### BACKGROUND

With the faster pace of life in modern society, more people experience emotional stress and physical discomfort, and are eager to seek avenues to relieve and relax their bodies. Therefore, various health care massage devices are increasingly entering people's lives. Using massage devices to massage the body can promote muscle relaxation and blood circulation, reduce muscle spasms, and relieve pain and fatigue.

Existing products of this type mostly use rotating motors as the driving force, where the rotor of the motor is linked to a swing arm to produce a swinging motion. The movement stroke of this type of device is fixed, making it impossible to adjust the swing amplitude of the product during operation, therefore limiting the experience of the user.

There is a need for development of new structure for massage devices to enhance user experience.

### SUMMARY OF THE INVENTION

In one aspect, the present disclosure provides a tapping apparatus, which comprises: a linear motor, a connecting member including a first end and a second end, and an elongated swing member, the linear motor including a mover that moves along a longitudinal axis, the mover being connected with the first end of the connecting member, and the second end of the connecting member is connected to the elongated swing member, wherein when the mover moves linearly back and forth, the elongated swing member rotates about a pivoting axis emanating from the connecting member. The pivoting axis can be perpendicular to the longitudinal axis.

In some embodiments, the connecting member comprises a first connecting component and a second connecting component being in movable connection with the first connecting component, and wherein the second connecting component includes a pivoting shaft extending in the direction of the pivoting axis, and wherein when the mover of the motor moves linearly back and forth, the elongated swing member rotates about the pivoting shaft.

In some embodiments, the first connecting component and the second connecting component are hingedly connected. In certain of these embodiments, the first connecting component and the second connecting component are slidably connected.

In some embodiments, the tapping apparatus further includes a barrier disposed along a first side of the elongated swing member such that the rotation of the elongated swing member is restricted by the barrier along the first side.

In some embodiments, the first connecting element includes a first portion and a second portion, the second portion forming a bent configuration with respect to the first portion. In some of these embodiments, the second portion of the first connecting element includes a sliding slot.

In some embodiments, the elongated swing member is made of a soft material.

The present disclosure also provides a massager comprising the tapping apparatus herein. In some embodiments, the massager comprises a casing having an inner wall, wherein the pivoting shaft is mounted on the inner wall of the casing. In some embodiments, the massager further includes a distal portion in which a vibration motor is positioned.

### BRIEF DESCRIPTION OF THE DRAWINGS

FIG. 1 is a schematic three-dimensional view of a partial structure of a tapping apparatus according to embodiments of the present invention.

FIG. 2 is a partial cross-sectional schematic view of a tapping apparatus according to embodiments of the present invention.

FIG. 3 is a schematic explosive view of a massager according to embodiments of the present invention.

FIG. 4 is a schematic cross-sectional structural view of the massager according to embodiments of the present invention.

FIG. 5 is a schematic perspective view of a massager according to embodiments of the present invention.

### DETAILED DESCRIPTION OF CERTAIN EMBODIMENTS

The embodiments of the present invention will be described below with reference to the accompanying drawings. Elements and features described in one figure or one embodiment of the invention may be combined with elements and features shown in one or more other figures or embodiments. It should be noted that for the purpose of clarity, the representation and description of structure/components or processes not relevant to the present invention and known to those of ordinary skill in the art have been omitted from the drawings and description herein.

The figures herein are schematic representations and the configuration of the different structures as well as their relative dimensions are intended to be illustrative only. When terms such as “upper” and “lower”, “above” and “below”, “top” and “bottom”, “right” and “left”, or similar relative expressions are used, these only refer to the arrangement of elements or structures in the accompanying figures and not necessarily to an actual situation of use. It is obvious that “down” can become “up” if an object is flipped or simply viewed from a different perspective.

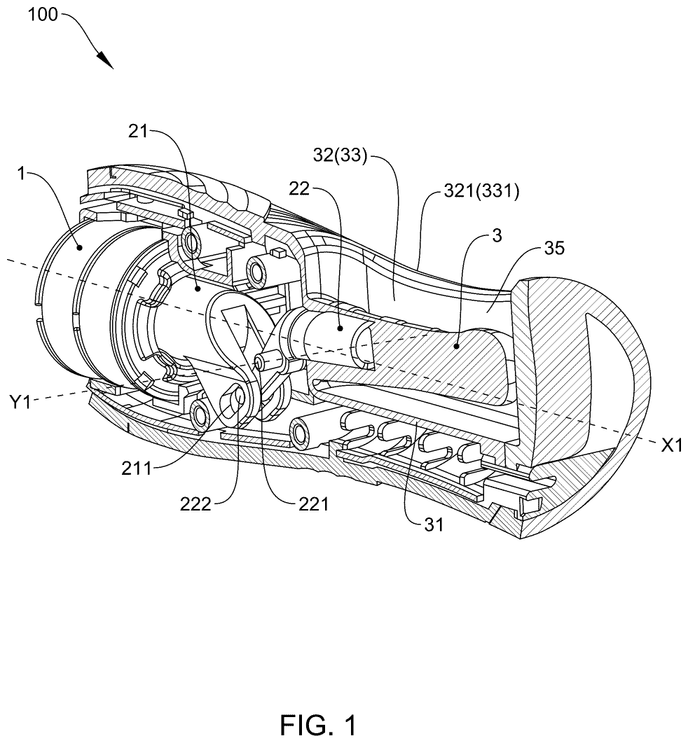

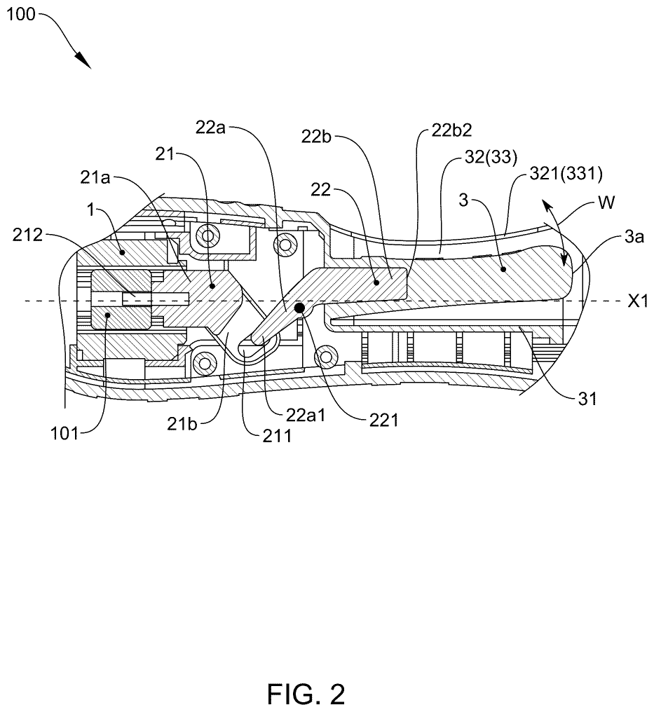

Referring to FIGS. 1-2, a tapping apparatus 100 of the present invention includes a linear direct-current (DC) motor 1, a connecting member 2, and an elongated swing member (or tapping member) 3. The linear motor 1 has a mover 101 that reciprocates along a longitudinal axis X1. The mover 101 is connected to a first end of the connecting member 2 via a protrusion portion 212 of the connecting member 2. The second end 22b2 of the connecting member 2 is connected to the elongated swing member 3.

The linear DC motor 1 can convert electrical energy into mechanical energy, and use the action of electromagnetic force to cause the motor to produce a linear motion. The linear motor includes a stator (not shown) and a mover 101. The stator can include a set of coils, and the mover 101 can include a set of permanent magnets. After energization, the current generated in the stator coil can generate a magnetic field, which interacts with the permanent magnets to generate electromagnetic force, pushing the mover 101 to move linearly back and forth along the longitudinal axis X1.

As shown, the connecting member 2 includes two parts: a first connecting component 21 and a second connecting component 22 that are movably connected with each other. The first connecting element 21 can include a first portion 21a and a second portion 21b. The first portion 21a can take a cylindrical configuration having a cylindrical axis substantially aligning with the longitudinal axis X1, and can partially enter into an interior space of the linear motor 4. The second portion 21b can form a bent configuration with respect to the first portion 21a, and can include two side prongs with a “U” configuration at cross-section. A slot (through window) 211 is provided on each of the side prongs. A first end of the first connecting component 21 (and of the connecting member 2) can include, or take a configuration of, a protrusion portion 212 with a narrowed cross-section, which can be frictionally coupled to (e.g., embedded in) the mover 101 of the linear motor. Of course, these two components can be connected in other manners as commonly known in the art.

The second connecting component 22 also includes two portions: a first portion 22a, and a second portion 22b. The first portion 22a includes a central plate generally extending at an angle (e.g., an obtuse angle as shown) from the second portion 22b. The second portion 22b can take a substantially cylindrical form and its distal end 22b2 partially inserted and embedded in the elongated swing member 3.

The first end 22al of the second connecting component 22 is provided with a protruding rod 222 on both sides respectively. The protruding rod 222 is placed in and engages the slots 211 of the first connecting component 21 and can slide along the slots 211. Thus, the first connecting component 21 and the second connecting component 22 are coupled in a sliding-hinge connection in this example (they can slide against each other while also being able to hingedly rotate about each other). Alternatively, the first connecting component 21 and the second connecting component 22 can be hingedly connected to each other while not being able to slide against each other (e.g., no sliding slot is provided). The hinged connection between the two components can also be accomplished by using a ball structure on the proximal end of the second connecting component (replacing the protruding rod 222) or a universal joint structure or the like.

A pivoting shaft 221 is provided on the second connecting component 22, as shown, near the middle of the first portion 22a. The pivoting shaft 221 can have a cylindrical cross-section and extends from the second connecting component 22 in a direction along a pivoting or rotating axis Y1 which is perpendicular to the longitudinal axis X1. When the first connecting component 21 moves forward and backward with the mover of the linear motor, the second connecting component 22 rotates about the pivoting shaft 221 (or the pivoting axis Y1) along the path W, driving the elongated swing member 3 to rotate accordingly. As a result, the elongated swing member 3 can move up and down as a whole when the mover 101 moves back and forth. The position of the pivoting shaft 221 can be adjusted as needed to allow desired swing range of the second connecting component 22.

An elongated chamber 35 enclosing the elongated swing member 3 includes a lateral side wall 32 having top edge 321 and an opposing lateral side wall 33 having a top edge 331, and a bottom barrier 31 (substantially parallel to the longitudinal axis X1) fixedly disposed adjacent and underneath the entirety of the elongated swing member 3. When swinging up, the distal end 3a of the elongated swing member 3 can move to a position above and beyond/outside the top edge of the chamber as the top of the chamber is open and communicative to the external space. However, the downward swing of elongated swing member 3 is blocked by the bottom barrier 31.

The first connecting component 21 can be made of a soft material, such as soft EVA, rubber and other materials. It can also be made of a hard or rigid material, such as plastic.

The elongated swing member 3 can take a generally rod-like shape, and can be made of an elastic material, such as silicone or rubber material, etc. As shown, the elongated swing member 3 can be made integrally with the bottom barrier 31, which extends from the proximal end of the swing member 3 to the distal end of the elongated chamber.

The tapping apparatus can also include a battery (not shown) for powering the linear motor.

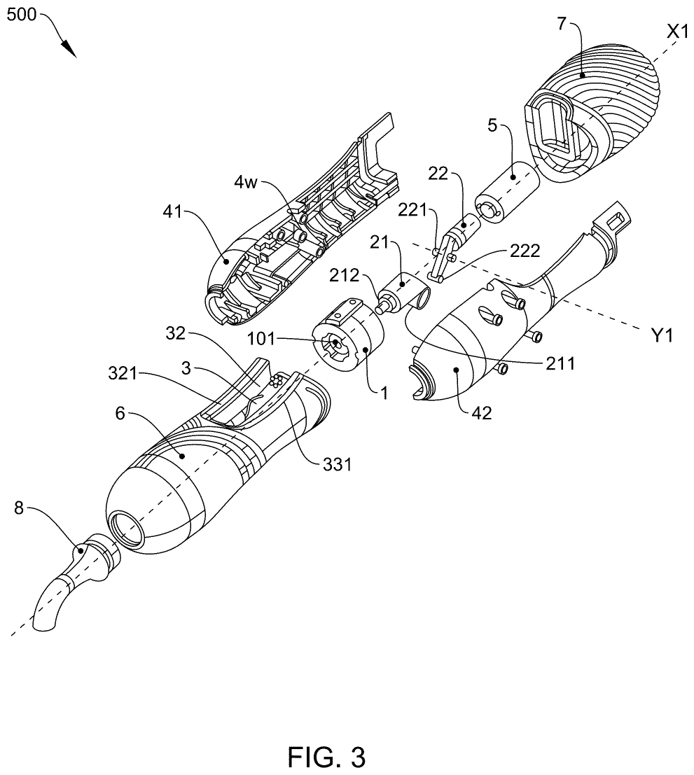

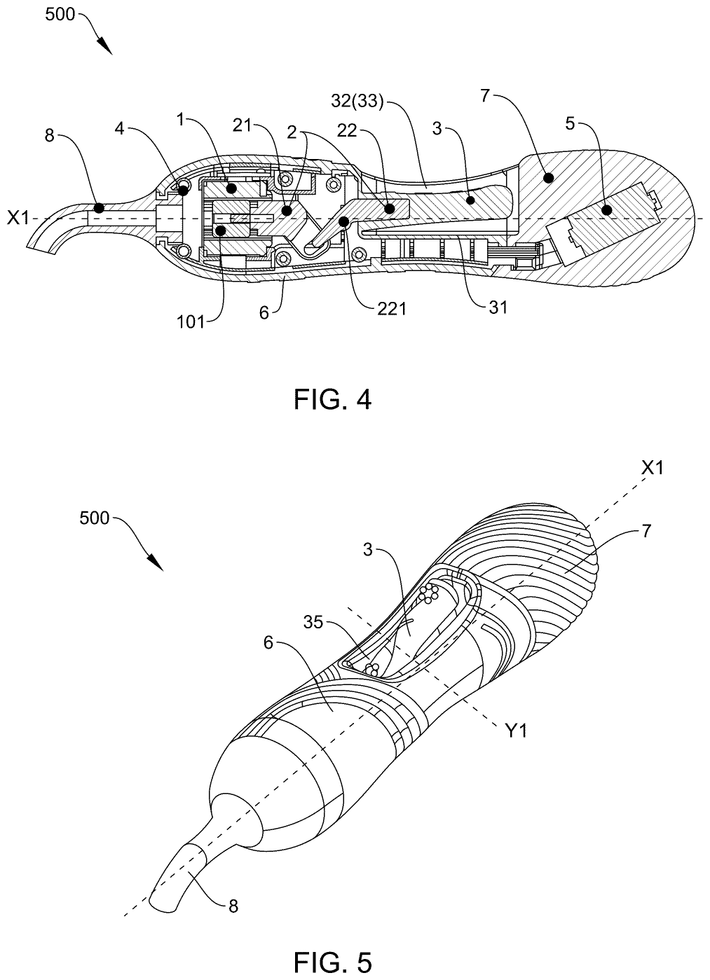

Referring to FIGS. 3-5, a massager 500 of the present invention can include the apparatus device with the above structure and a casing 4. The casing 4 includes a first casing part 41 and a second casing part 42. The first casing part 41 and the second casing part 42 can be closed (by screws or friction or other means commonly known in the art) to provide a space or opening for accommodating components of the tapping apparatus such as the connecting member 2 and elongated swing member 3. The pivoting shaft 221 of the tapping apparatus as described herein can be fixedly mounted on an inner wall 4w of the casing 4.

The massager 500 also includes a vibration motor 5, which generates vibration through the movement of the vibration motor, which can further massage the user's body part for muscle relaxation or stimulation. The vibration motor 5 is provided at a distal portion 7 of the massager, and the distal portion 7 can be made of elastic material. For example, the massager can be configured and dimensioned such that the distal end 7 of the massager may be inserted into a vagina to provide a vibration inside the vagina, and the elongated swing member 3 moves about and tap a female erogenous zone near the opening of the vagina, such as the clitoris, so as to provide multiple modes of stimulations.

An elastic sleeve 6 can be used to enclose the casing 4. The elastic sleeve 6 can be made of elastic material, such as silicone or other flexible and elastic materials. The elastic sleeve 6 can be integrated with the elongated swing member 3 (as shown in FIGS. 1, 2, and 4). The lateral side wall 32 as described herein enclosing the elongated chamber 35 (in which the elongated swing member moves about) can be formed by a part of sleeve 6 wrapping around a part of the casing 4 surrounding the elongated swing member.

The proximal end of the massager in this embodiment can be provided with a silicone rope 8 for the user to carry.

The linear motor and vibration motor of the massager can be powered by an internal or external power supply, and the internal power supply is a rechargeable battery or a disposable battery. The stroke distance and reciprocating frequency of the mover of the linear motor can be adjusted to control the movement of the elongated swing member, thereby providing different intensity, pressure and tapping experience.

The side wall of the casing can be provided with a charging socket that matches the rechargeable battery, and can be connected to an external power source to charge the rechargeable battery.

The massager can also include a control circuit board equipped with control switches that are connected to the power supply and the motor, respectively. The control circuit board can be fixed on the inner wall of the casing, and the control switch can be exposed outside the casing to facilitate user control.

For improved user experience, the shape of the elastic sleeve can be generally conformant to the shape of the casing. The shape can be any shape as long as it is convenient and comfortable for the user to grasp. The elastic sleeve can be made with elastic materials such as rubber or silicone, EVA and other elastic materials. Silicone is preferred as it is skin-friendly, has good flexibility and elasticity, high mechanical strength, and resistant to wear and tear.

The stroke of a traditional rotating motor using a crankshaft driving mode is limited by design factors such as the structure of the crankshaft. In contrast, the motion range of a linear motor used in the present invention can be easily adjusted according to the needs of a user. As a result, the tapping stroke distance, as well as the tapping strength and pressure of the tapping apparatus of the present invention can be varied in a great range as desired by the user.

Although the present invention and its advantages have been described in detail, it should be understood that various changes, substitutions and alterations can be made without departing from the spirit and scope of the invention as defined by the appended claims. Furthermore, the scope of the present application is not limited to the specific embodiments of the apparatus, structure, processes, means, methods and steps described in the specification. Those of ordinary skill in the art will readily understand from the disclosure of the present invention that existing and existing devices that perform substantially the same functions or obtain substantially the same results as corresponding embodiments described herein may be used in accordance with the present invention. Accordingly, the appended claims are intended to include within their scope such processes, apparatus, structure, means, methods or steps.

1. A tapping apparatus, comprising:
a linear motor including a mover that moves along a longitudinal axis, a connecting member including a first connecting component and a second connecting component, and an elongated swing member, the mover being connected with the first connecting component, and the second connecting component is connected to the elongated swing member, the second connecting component being in a slidable connection with the first connecting component, wherein when the mover moves linearly back and forth along the longitudinal axis, the first component moves linearly back and forth along with the mover, thereby causing the second connecting component to rotate about a pivoting axis perpendicular to the longitudinal axis, which in turn causes the elongated swing member to rotate about the pivoting axis.

2. The tapping apparatus according to claim 1, wherein the second connecting component includes a pivoting shaft extending in the direction of the pivoting axis, and wherein when the mover of the motor moves linearly back and forth along the longitudinal axis, the second connecting member rotates about the pivoting shaft.

3. (canceled)

4. (canceled)

5. The tapping apparatus according to claim 1, further comprising a barrier fixedly disposed along a first side of the elongated swing member such that the rotation of the elongated swing member is restricted on the first side by the barrier.

6. The tapping apparatus according to claim 1, wherein the first connecting component includes a first portion and a second portion, the second portion forming a bent configuration with respect to the first portion.

7. The tapping apparatus according to claim 6, wherein the second portion of the first connecting component includes a sliding slot.

8. The tapping apparatus according to claim 1, wherein the elongated swing member is made of a soft material.

9. (canceled)

10. (canceled)

11. A massager comprising the tapping apparatus of claim 1.

12. (canceled)

13. The massager according to claim 11, further comprising a casing including an inner wall, wherein the pivoting shaft of the tapping apparatus is mounted on the inner wall of the casing.

14. The massager according to claim 13, further including a distal portion in which a vibration motor is positioned.

15. A massager, comprising:
a casing;
a linear motor enclosed in the casing, the linear motor including a mover that moves along a longitudinal axis;
an elongated swing member;
a connecting member including a first connecting component and a second connecting component, wherein the mover is connected with the first connecting component, and the second connecting component is connected to the elongated swing member, wherein the first connecting component includes a first portion and a second portion, the first portion having a first end coupled with the mover, and the second portion forming a bent configuration with respect to the first portion, and wherein the second portion includes a sliding slot, wherein the second connecting component including a pivoting shaft mounted on an inner wall of the casing and extending in a direction perpendicular to the longitudinal axis, the pivoting shaft slidably engaging the sliding slot of the first connecting component,
wherein when the mover moves linearly back and forth along the longitudinal axis, the first component moves linearly back and forth along with the mover, thereby causing the second connecting component to rotate about the pivoting shaft, which in turn causes the elongated swing member to rotate about the pivoting axis and in an elongated chamber formed by the casing.
